(19) United States
(12) Patent Application Publication
(10) Pub. No.: US 2002/0198773 A1
(43) Pub. Date: Dec. 26, 2002

(54) Method and system for managing innovation by encouraging reusability and subsequent reuse of design components

(75) Inventors: Wendy Ann Belluomini, Austin, TX (US); Juan-Antonio Carballo, Austin, TX (US); Nicholas M. Donofrio, Ridgefield, CT (US); Robert Kevin Montoye, Austin, TX (US); Kevin John Nowka, Round Rock, TX (US)

Correspondence Address: Joseph P. Lally, DEWAN & LALLY, L.L.P., P.O. Box 684749, Austin, TX, 78768-4749, US

(73) Assignee: International Business Machines Corporation

(21) Appl. No.: 09/891,343

(22) Filed: Jun. 26, 2001

(51) Int. Cl. G06F 17/60; G06F 17/50

(52) U.S. Cl. 705/14; 716/1

(57) ABSTRACT

A method and system for designing electronic devices by encouraging reuse as a design principle and rewarding both the design of reusable components as well as the subsequent reuse of such components. Typically, a design team evaluates each component in a proposed device for its potential to be implemented with a previously designed component. If a decision is made to forego previously designed components, the design team is encouraged to incorporate re-usability principles into the component design by a reward or compensation structure that rewards both the individual members of a team as well as the corporate entity to which the design team is assigned. The reward structure also encourages teams to use existing designs wherever possible by rewarding a team that reuses an existing component. An innovation administrator may adjust the relative rewards for incorporating reusability into a design vs. reusing a design to effect a preference for innovation in selected areas.

### BACKGROUND

1. Field of the Present Invention

The present invention generally relates to the field of innovation management and more particularly to a method and system for encouraging both the design of re-usable components and the reuse of existing components in a corporate environment.

2. History of Related Art

The designers and manufacturers of electronic devices such as microprocessors, memories, telecommunications chips, and other complex devices are frequently large corporations that are fragmented into smaller entities such as divisions or product groups and still further fragmented into design teams that work on specific devices. A design team is typically assigned the task of designing a device according to some specification, market demand, customer requirement, or some combination thereof Almost universally, a paramount determinant of the design team's success is the amount of time required to implement and verify an acceptable design. Decreases in product life cycles for high technology devices have elevated the importance of achieving a fast design cycle. Unfortunately, electronic design automation (EDA) tools have failed to keep pace with the exponential growth in transistor counts thereby exacerbating the design cycle dilemma. Verification of new microprocessor designs can consume 50% or more of the entire cycle design. Faced with unrealistic design schedules, designers typically have strong disincentives to engage in design practices that do not contribute directly to the rapid completion of the design. Extensive documentation is an example of a generally beneficial design practice that is typically foregone in an effort to meet an administratively imposed schedule.

By designing products that are just good enough to meet the current criteria in an effort to meet a design schedule, electronic device designers have little opportunity to reuse previously developed devices or device components, or to construct components so as to make them available for reuse by other designers. In other words, the design environment and the incentives that are currently in place result in little, if any, effort to evaluate the potential for reuse in the design of a new product. Because, however, reuse offers the potential for a low cost method of reducing the design cycle time, it would be highly desirable to implement a method and system that encouraged reuse of previously developed devices and created incentives to design re-usable devices.

### SUMMARY OF THE INVENTION

The problems identified above are in large part addressed by a method and system for managing innovation within a corporation by encouraging reuse as a design principle and rewarding both the design of highly re-usable components as well as the subsequent reuse of such components in future designs. Typically, a team is assigned the task of designing an electronic device that includes one or more components. Each component is evaluated in terms of its potential for being implemented with a previously designed component. If a decision is made to forego previously designed components, the design team is encouraged to incorporate re-usability principles into the component design by a reward or compensation structure that rewards both the individual members of a team as well as the corporate entity to which the design is assigned (be it a division, product line, etc). The reward structure also encourages teams to use existing designs wherever possible by rewarding a team that reuses an existing component. This reuse reward is in addition to the presumably shorter design time enabled by using the existing design. An innovation administrator may adjust the relative rewards for incorporating reusability into a design vs. reusing a design to effect a preference for innovation in selected areas. In a mature technology, for example, the relative reward for re-using existing components vs. designing a new component may be increased while the opposite structure might be implemented in a developing area.

### BRIEF DESCRIPTION OF THE DRAWINGS

Other objects and advantages of the invention will become apparent upon reading the following detailed description and upon reference to the accompanying drawings in which:

FIG. 1 is a flow diagram illustrating a method of innovation management according to one embodiment of the invention;

FIG. 2 is a block diagram of a system for managing innovation according to one embodiment of the invention; and

FIG. 3 is a block diagram showing selected features of a software system for encouraging reusability in the design of an electronic device according to one embodiment of the invention.

While the invention is susceptible to various modifications and alternative forms, specific embodiments thereof are shown by way of example in the drawings and will herein be described in detail. It should be understood, however, that the drawings and detailed description presented herein are not intended to limit the invention to the particular embodiment disclosed, but on the contrary, the intention is to cover all modifications, equivalents, and alternatives falling within the spirit and scope of the present invention as defined by the appended claims.

### DETAILED DESCRIPTION OF THE INVENTION

Generally speaking, the present invention contemplates a method and system for managing innovation within a corporation to encourage the design of reusable components within the corporation. Rapid technological evolution has imposed dual constraints on the designers and manufacturers of technology devices including electronic components and computer software. First, increasing technological capabilities have resulted in an increase in the complexity of electronic devices. These increasingly complex devices require more time to design and verify. EDA tools, unfortunately, have not kept pace with the rapid increase in the complexity of devices. Accordingly, the verification phase of the design process is consuming an increasingly large percentage of the entire design cycle. Simultaneously, the rate at which technology evolves has decreased the profitable market life time of technology products.

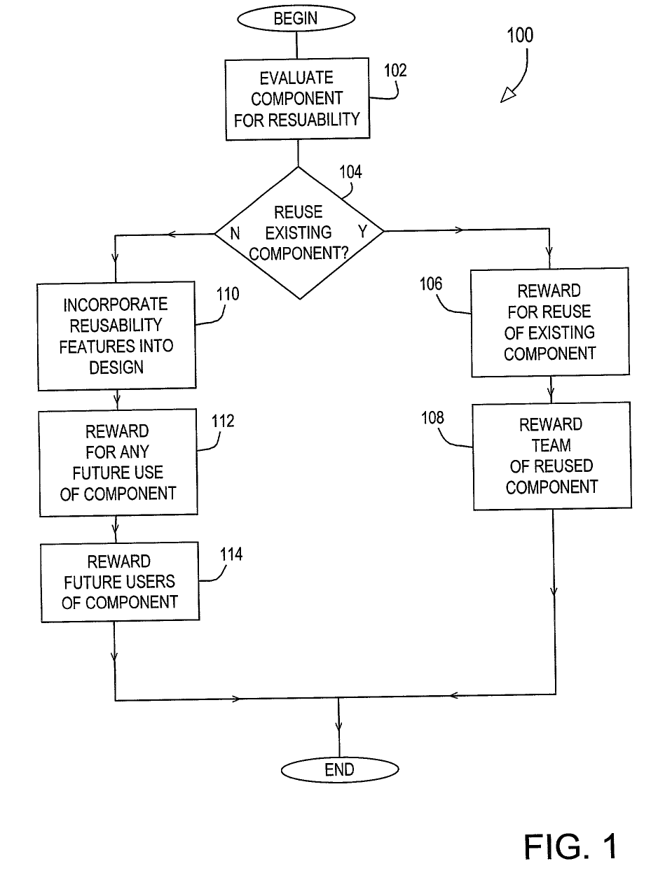

Turning now to FIG. 1, a flow diagram of a method 100 for managing innovation within a corporation to encourage the design of reusable components and to encourage subsequent reuse of existing components is presented. In the depicted embodiment, it is assumed that the requirements for a device have been defined. Typically, the device includes one or more pieces referred to herein as device components or simply components. The task of designing a device meeting the specified requirements is typically assigned to a design team by the management of a corporate entity such as a product line or a division. This entity and its management are referred to herein as the sponsor of the new design.

The sponsor assigns the design task to a design team. The design team is then charged with the task of designing a suitable device that meets all the specified requirements of the market and/or customers within a certain time frame. In the corporate environment, the success of the design team is determined largely on the time the team requires to complete a successful design. Under these circumstances, it will be apparent to those skilled in the field of electronic design that there is little incentive and may be strong disincentives to engaging in design practices that might prove beneficial to some other design team within the corporation at some future point in time. To the contrary, the incentives in a typical design environment are to generate a device in the absolutely shortest time possible. Practices which do not contribute directly to the task of completing a design quickly are typically scrapped entirely or substantially curtailed. Documentation, for example, is an example of a design practice that is generally accepted as desirable, but which does not typically contribute directly to the goal of completing a design quickly. Extensive documentation is a painstaking and time-consuming task that is more likely to delay the completion of a successful design than speed it up.

One approach to speeding up the design cycle is to use previously existing devices or device components in the design of a new device. Reusing existing components beneficially reduces the amount of time required to verify the design and may significantly reduce the time required to verify or otherwise test the device. Because, however, the incentives in a conventional organization do not encourage reuse, the invention contemplates a method and system for encouraging and rewarding reusability within the corporation.

Turning now to FIG. 1, a flow diagram depicting a method 100 for managing innovation within a corporation by encouraging the design of re-usable components and encouraging the use of previously existing components according to one embodiment of the invention is depicted. It is assumed that the requirements for a specific device have been identified and described by a sponsor of the device and assigned to a design team. The design team may initially determine, as is frequently the case with complex devices, that the device includes one or more device components. The method 100 illustrates the process by which the corporation encourages the design team to either design each component with an eye toward future reuse or to use a previously designed component wherever feasible.

Thus, for each component in a design, the design team initially evaluates (block 102) opportunities for re-using an existing component in the current design. Evaluating opportunities for reuse may include first determining if a component exists that performs the required function at the required level of performance. Assuming a functionally suitable existing component is available, evaluating opportunities for re-using that component may include determining whether the pre-existing component exists in a format suitable for current purposes (e.g., is there an HDL model of the component available), evaluating the interfaces used for the component to determine compatibility for the current purposes, and evaluating the documentation and level of verification associated with the existing component to gauge whether the quality level of the existing component is sufficient for the current purposes. After evaluating the opportunity for re-using an existing component, a decision is made (block 104) to either use an existing component for the component under consideration or to design a new component from scratch.

If the design team determines that it is necessary or preferable to design an entirely new component, the present invention contemplates that the design team will be encouraged to design the new component in a manner that promotes subsequent reuse of the component. Thus, the design team incorporates (block 110) re-usability features into the new component. These re-usability features may include “over provisioning” the component by incorporating performance features that exceed the minimum performance requirements of the component under consideration, incorporating standardized interfaces into the design to facilitate subsequent reuse, and documenting the design and its verification sufficiently to enable a subsequent design team that is unfamiliar with the component to implement the component into their design.

To encourage design teams to engage in the extra time, effort, and expense required to incorporate re-usability into a project, method 100 includes a structure for rewarding (block 112) the design team and the team's sponsor for any subsequent reuse of the component. The reward includes, direct compensation to the design team members for each subsequent reuse of the design or indirect compensation such as stock options. The compensation may be immediate or deferred over time such as by granting stock options with staggered vesting dates to encourage team member retention.

In addition to providing incentives to the innovation producer (the design team), one embodiment of the invention contemplates rewarding the design team's sponsor for subsequent reuse of a component. While the reward to a technology sponsor could come in the form of direction compensation to the sponsoring agent's management team (again in the form of cash or stock options) it may be of more value to encourage technology sponsors to promote reusability principles by offering sponsors compensation in the form of additional man power. In a high technology area, attracting and retaining sufficient qualified personnel is a major challenge. By offering additional engineers, designers, and programmers to technology sponsors, the invention proposes to provide motivation to technology sponsors that is sufficient to encourage them to take an active role in promoting re-usability.

To optimize opportunities for reuse within an organization, method 100 rewards not only the producers of reusable components (i.e., the design teams and technology sponsors), but also the consumers of re-usable components. When a subsequent design team reuses (block 114) a previously developed product, they may be rewarded in the same manner as the producer of the reusable device or component. The compensation to the subsequent design team (referred to as the innovation consumer) may be lower than the compensation paid to the innovation producer to reflect the relative efforts that each party extended with respect to the particular device or component. Nevertheless, by incorporating direct compensation to the consumer of previously developed technology, the method 100 gives design teams dual incentives for thoroughly evaluating opportunities for reuse when designing a device. In addition to the time and effort that will be saved by re-using an existing component, the design team will be compensated for its reuse efforts.

Returning back to the decision block 104, the team designing a new device may determine that there is an opportunity for reuse with respect to one or more components of the design. If the design team decides to reuse an existing device or component, the design team is rewarded (block 106) for doing so in the same manner that the subsequent design team was rewarded for its reuse efforts in block 114. Similarly, when a design team decides to reuse a previously developed device or component, the producers of the design are rewarded (block 108).

In this manner, a design team charged with designing a new device will be motivated to evaluate each component of the device for reuse opportunities. With respect to each component, the design team will have incentives to become an innovation producer by designing a component that may be reused in subsequent designs for years to come as well as incentives to become an innovation consumer by using a previously developed design for one or more components. By managing the relative incentives for reuse v. new design, an innovation managing agent can influence how much reuse is undertaken. In emerging technological areas, the innovation manager may create relatively strong incentives to design reusable components and relatively weak incentives for reuse while, in a mature field, the innovation manager may create the opposite bias.

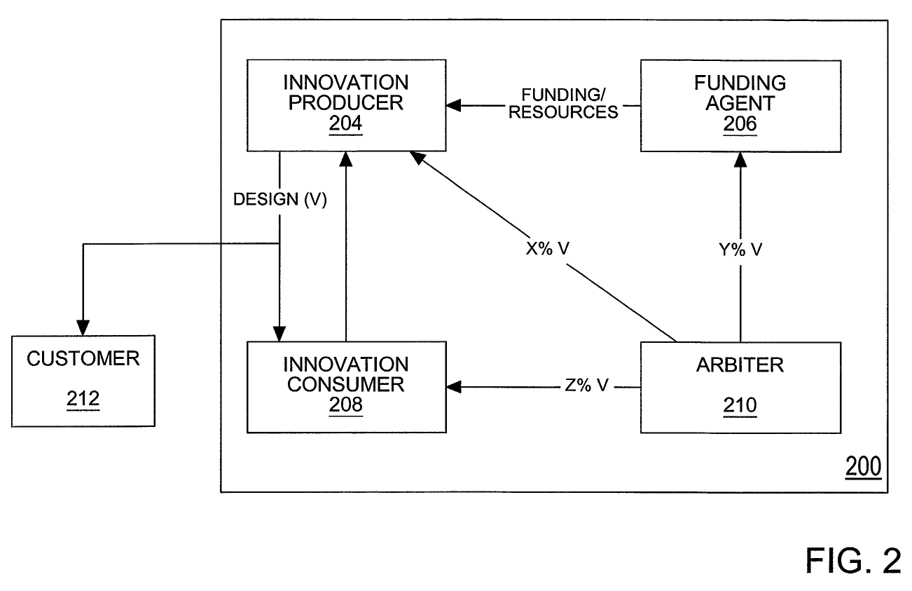

Turning now to FIG. 2, a block diagram illustrating selected elements of a system 200 in which the innovation management method described above is implemented. In the depicted embodiment, the organization 200 includes at least one innovation producer 204 who is governed or supported by a funding agent 206. In addition, the organization 200 includes an innovation consumer 208 and an innovation arbiter 210. Innovation producer 204 may represent the design team of a reusable component or product as described previously. Upon successfully completing and implementing the design of a reusable component, the reusable component is available for reuse by innovation consumer 208, which may represent a design team working on a subsequent device.

Arbiter 210 represents the innovation manager referred to above. Arbiter 210 is typically responsible for creating the incentive structure for each reuse transaction. Arbiter 210 may be responsible, as an example, for determining the value (V) of a reusable device or component developed by innovation producer 204. In some cases, the innovation consumer is an outside customer 212 and the value V reflects the price paid by customer 212 to obtain the design. In other cases, an innovation consumer 208 is internal to the organization and V is determined according to some valuation methodology.

In addition to determining valuations, arbiter 210 may determine the rewards or compensation that each party to a reuse transaction receives. The reward structure may be based directly on the value V such that, for example, innovation producer 204 may receive X% of V each for each reuse transaction involving the device or component while funding agent 206 receives Y% of V and innovation consumer 208 receives Z% of V for each reuse transaction. In other embodiments, the compensation awarded for each reuse transaction may be determined according to a non-linear formulation. Innovation consumer 208 might, for example, receive a fixed sum instead of a percentage of the valuation. Also, as indicated previously, funding agent 206 might receive alternative forms of compensation such as increased personnel (head count) or an increase in its existing budget.

Portions of the present invention may be implemented as a sequence or set of computer executable instructions (software) that are stored on a computer readable medium. When the software is being executed, portions of the software may reside in a volatile storage medium such as the system memory (DRAM) or cache memory (SRAM) of a data processing system. At other times, portions of the software may reside in a non-volatile medium such as a hard disk, floppy diskette, CD ROM, DVD, magnetic tape, flash memory card, or other suitable medium.

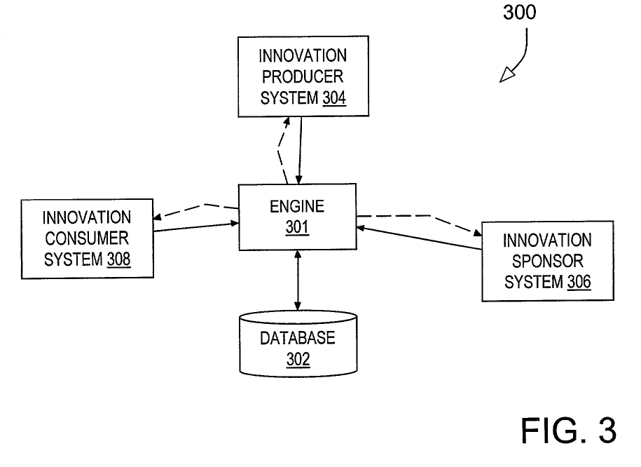

Turning now to FIG. 3, a block diagram of selected features of a software system 300 for facilitating the innovation management system described herein is presented. In the depicted embodiment, the software system 300 includes an engine 301 that works in conjunction with an innovation producer system 304, an innovation sponsor system 306, and an innovation consumer system 308 to coordinate and facilitate reuse transactions in which a design team reuses a component previously designed by the innovation producer.

In this arrangement, the innovation producer system 304 may include information such as the status of components or devices that are in progress, the level of verification and testing, the computer formats in which the components exist, and the expected completion date of designs-in-progress. The innovation sponsor system 306 would typically include higher level information regarding each component or device in progress. This information might include the resources (i.e., man-hours and/or dollars) that have been invested in a design, the number of reuse transactions contemplated or completed for each design, and so forth. The innovation consumer system 308 would include reuse transaction information such as the identity of the innovation consumer, the effective date of a reuse transaction, the identity of the reusing design team, the identity of the reused design and its corresponding design team and sponsor. The engine 301 would typically be responsible for collecting the information provided by each of the component systems and storing the information in a centralized data base. From this information, the engine might generate the compensation transactions that accompany each reuse transaction.

In another embodiment, the innovation consumer system 308 might include technical information concerning the function of a particular design, the architecture of the design's interface (number of IO's, etc.) and even information such as the identity of the principal designers and whether or not those designers are still within organization 300. Similarly the innovation producer system 304 might include analogous technical information for each of its designs. In this embodiment, the engine 301 may be configured not only to track and generate reuse transactions and the corresponding incentive payments to be made, but also to participate and facilitate the reuse decision itself. It will be appreciated by those in the field of software development that, although the depicted illustration indicates a single system 300 with a plurality of components, the actual system may be implemented in a distributed or client-server fashion such that portions of the system 300 reside on one or more client devices (not explicitly depicted) while other portions reside on one or more server systems.

It will be apparent to those skilled in the art having the benefit of this disclosure that the present invention contemplates a method and system for managing innovation. It is understood that the form of the invention shown and described in the detailed description and the drawings are to be taken merely as presently preferred examples. It is intended that the following claims be interpreted broadly to embrace all the disclosed embodiments and their equivalents.

What is claimed is:

1. A method of designing an electronic device, comprising:
for at least one component of the device, evaluating the opportunity for re-using an existing design for the component;
responsive to declining to reuse an existing design, creating a reusable design for the component;
determining a value for the reusable design; and
responsive to a reuse transaction comprising the subsequent reuse of the reusable design, compensating an innovator of the reusable design.

2. The method of claim 1, further comprising, responsive to the reuse transaction, compensating a consumer of the reusable design.

3. The method of claim 1, further comprising, responsive to the reuse transaction, compensating a funding agent of the reusable design.

4. The method of claim 3, wherein compensating the funding agent comprises increasing the funding agent's personnel.

5. The method of claim 1, wherein creating a reusable design comprises incorporating a standard interface into the design.

6. The method of claim 1, wherein creating a reusable design comprises incorporating performance features exceeding the performance requirements of

7. The method of claim 1, wherein compensating the innovator comprises compensating in proportion to the determined value of the design.

8. The method of claim 1, wherein the determined value reflects a market value for the design.

9. The method of claim 1, further comprising, responsive to identifying an existing design suitable for reuse, incorporating the existing design into the electronic device and compensating the innovator of the existing design.

10. The method of claim 9, further comprising, compensating for reusing the existing device.

11. A method of designing an electronic device, comprising:
for at least one component in the design of the device, determining whether any existing designs are suitable for use as the component,
responsive to identifying a suitable existing design, incorporating the suitable existing design into the device;
compensating the innovator of the suitable existing design; and
compensating the consumer of the suitable existing design.

12. The method of claim 11, further comprising compensating a funding agent of the innovator.

13. The method of claim 11, further comprising determining a value for the suitable existing design and wherein compensating the innovator and consumer comprises compensating the innovator and consumer based upon the determined value.

14. The method of claim 11, further comprising:
responsive to declining to use an existing design, creating a reusable design for the component and
responsive to a reuse transaction comprising the reuse of the reusable design, compensating the innovator of the reusable design.

15. The method of claim 14, further comprising: responsive to the reuse transaction, compensating the consumer of the reusable design.

16. The method of claim 15, further comprising responsive to the reuse transaction, compensating a funding agent of the innovator.

17. A system for designing an electronic device, comprising:
an innovation producer enabled to create a reusable design for at least one component of a first device;
an innovation consumer enabled to reuse the reusable design for at least one component of a second electronic device; and
an arbiter enabled to determine a value of the reusable design and to compensate the innovation producer based on the determined value responsive to the reuse of the design.

18. The system of claim 17, wherein the arbiter is further enabled to compensate the innovation consumer based on the determined value.

19. The system of claim 18, wherein the funding agent is enabled to adjust the relative compensation to the innovation producer and innovation consumer to encourage reuse accordingly.

20. The system of claim 17, further comprising a funding agent enabled to provide resources to the innovator producer.

21. The system of claim 20, wherein the arbiter is enabled to compensate the funding agent responsive to the reuse of the design.

22. The system of claim 21, wherein the compensation to the funding agent comprises additional personnel.
